(19) United States
(12) Patent Application Publication
(10) Pub. No.: US 2026/0299889 A1
(43) Pub. Date: Oct. 1, 2026

(54) DRILLING INTO BILLING REPORTS

(71) Applicant: Schlumberger Technology Corporation, Sugar Land, TX (US)

(72) Inventors: Christopher Lunny, Menlo Park, CA (US); Chen Lin, Menlo Park, CA (US); Jiwon Lee, Menlo Park, CA (US); Param Jayesh Mamania, Los Angeles, CA (US); Jagan Mohan Gottimukkula, Menlo Park, CA (US); Apoorva Dubey, Menlo Park, CA (US); Sandeep Sekhar Bathala, Los Angeles, CA (US)

(21) Appl. No.: 19/092,631

(22) Filed: Mar. 27, 2025

(51) Int. Cl. G06F 8/30

(52) U.S. Cl. CPC G06F 8/30

(57) ABSTRACT

The present disclosure relates to systems and methods for identifying metrics of different features of an application operated by microservices of the application running on a cloud service provider. The systems and methods generate a data structure for the microservices using the telemetry data obtained from the application and the microservice metric obtained for the microservices. The systems and methods use the data structure to determine a metric of different features of the application.

### BACKGROUND

Applications running on cloud service providers typically use shared infrastructure to save cost. Existing solutions attempt to maximize the business value of the cloud, enabling timely data-driven decision making and creating financial accountability through collaborations between engineering, finance, and business teams. However, the billing data provided by cloud service providers is not granular enough to account for the cost of internal details of an application.

### BRIEF SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some implementations relate to a method. The method includes obtaining telemetry of a span of an application operating on a cloud service provider. The method includes obtaining a microservice metric of a microservice of the application running on the cloud service provider executing the span. The method includes generating, using the telemetry and the microservice metric, a data structure with a plurality of buckets for the microservice, wherein each bucket of the plurality of buckets includes a time stamp and the microservice metric for the time stamp. The method includes associating a time frame of the span to a subset of buckets of the plurality of buckets. The method includes determining, using the data structure, a span metric of the span by aggregating the microservice metric of the subset of buckets. The method includes outputting the span metric.

Some implementations relate to a device. The device includes a memory to store data and instructions; and a processor operable to communicate with the memory, wherein the processor is operable to: obtain telemetry of a span of an application operating on a cloud service provider; obtain a microservice metric of a microservice of the application running on the cloud service provider executing the span; generate, using the telemetry and the microservice metric, a data structure with a plurality of buckets for the microservice, wherein each bucket of the plurality of buckets includes a time stamp and the microservice metric for the time stamp; associate a time frame of the span to a subset of buckets of the plurality of buckets; determine, using the data structure, a span metric of the span by aggregating the microservice metric of the subset of buckets; and perform an action in response to the span metric.

Some implementations relate to a computer-readable storage medium including instructions that, when executed by a processor, cause the processor to: obtain telemetry of a span of an application operating on a cloud service provider; obtain a microservice metric of a microservice of the application running on the cloud service provider executing the span; generate, using the telemetry and the microservice metric, a data structure with a plurality of buckets for the microservice, wherein each bucket of the plurality of buckets includes a time stamp and the microservice metric for the time stamp; associate a time frame of the span to a subset of buckets of the plurality of buckets; determine, using the data structure, a span metric of the span by aggregating the microservice metric of the subset of buckets; and perform an action in response to the span metric.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for identifying metrics of features of an application running on a cloud service provider in accordance with implementations of the present disclosure.

FIG. 2 illustrates example traces and spans in accordance with implementations of the present disclosure.

FIG. 3 illustrates an example data structure in accordance with implementations of the present disclosure.

FIG. 4 illustrates an example span divided into buckets of a data structure in accordance with implementations of the present disclosure.

FIG. 5 illustrates an example activity array in accordance with implementations of the present disclosure.

FIG. 6 illustrates an example method for identifying metrics of features of an application running on a cloud service provider in accordance with implementations of the present disclosure.

FIG. 7 illustrates components that may be included within a computer system in accordance with implementations of the present disclosure.

### DETAILED DESCRIPTION

This disclosure generally relates to cloud computing. Applications running on cloud service providers typically use shared infrastructure to save cost. Many applications on the cloud employ a microservices architecture involving running many small services on a shared cluster of servers using orchestration tools, such as, KUBERNETES. A workflow performed in an application can use several of the microservices in one or more user-initiated application programming interface (API) calls, or in automated workflows.

Existing solutions attempt to maximize the business value of the cloud, enabling timely data-driven decision making and creating financial accountability through collaborations between engineering, finance, and business teams. The billing data provided by cloud service providers is not granular enough to account for the cost of internal details of an application.

One example existing solution for monitoring and observing applications or systems for debugging, troubleshooting, and performance optimization is OpenTelemetry. OpenTelemetry is an observability framework and toolkit designed to create and manage telemetry data, such as, traces, metrics, and logs. One example existing solution for cost information is OpenCost. OpenCost uses infrastructure metrics to attribute costs to sub-application units (e.g., clusters, namespaces, pods, services).

Existing solutions can provide the cost of individual microservices. However, existing solutions lack visibility into the architecture of an application and are unable to measure the cost of sub-application-level aspects and user sessions. Existing solutions are unable to identify how the traces of application programming interface (API) calls relate to each other from an application perspective and are unable to provide information on the cost of an application workflow.

The present disclosure provides systems and methods for attributing infrastructure metrics to granular aspects of an application. In some implementations, the infrastructure metrics is a cost associated with the application. One example of a cost is a monetary cost. Another example of a costs is a resource cost. The systems and methods combine application telemetry and tagging with infrastructure metrics to attribute infrastructure cost to different aspects of an application or user session. The present disclosure includes a number of practical applications that provide benefits and/or solve problems associated with cloud computing. Examples of these applications and benefits are discussed in further detail below. One example benefit of the systems and methods of the present disclosure is providing detailed cost attribution to different aspects of a software application. Engineering and business teams can use the cost in making data-driven decisions around pricing, deployments, and application design. The systems and methods aid users in obtaining detailed cost information for individual users of an application as well as the expenses associated with specific workflows within an application.

Another example benefit of the systems and methods of the present disclosure is providing actional recommendations on resource management. The granular metric insights provided by the systems and methods enable end users to make informed decisions regarding resource allocation, identifying which resources are disproportionately expensive and not yielding profitable returns. Another example benefit of the system and methods of the present disclosure is flexibility in obtaining the metric information for areas of interest. The systems and methods can tailor the metric information provided to a specific area of interest of the application.

In some implementations, tags are added to the code of the systems and methods making it more transparent to identify which resource is utilized when a function is called. Telemetry is the collection of metrics (e.g., duration of an API request, start time and end time of an operation, system error rate, central processing unit (CPU) utilization, request rate, etc.), logs, and traces at remote points and the automatic transmission of this data to receiving endpoints for monitoring. For example, the tags are selected according to the area of interest (e.g., user session, application workflows, application features, or any other relevant tag for which a metric-breakdown may be of interest), and the tags are added to the telemetry data labeling the telemetry data with the application activity or user session where the telemetry originated. In some implementations, systems and methods use the tags in the telemetry to monitor the metric of the area of interest in the application.

In some implementations, the systems and methods use an algorithm to attribute costs to different aspects of the application using the telemetry data and the tags identifying different aspects of the application. For example, the systems and methods use the algorithm to calculate a cost of a workflow in an application spanning multiple microservices and the algorithm uses the tags to identify the telemetry data for the workflow. Another example includes the systems and methods using the algorithm to calculate the cost of a feature of the application where the algorithm uses the tags to identify the telemetry data for the feature of the application. Another example includes the systems and methods using the algorithm to calculate the cost per user of the application.

In some implementations, metrics are used to perform an action on the application. One example action is redesigning the application based on the cost information (e.g., a feature in the application is expensive to host but used less frequently compared to other features, the feature may be moved onto infrastructure that has cheaper base cost). Another example action includes changing the pricing structure of a feature of the application to increase profitability of the application in response to cost information (e.g., a feature of the application that is profitable and used frequently, can be available on a paid tier of subscriptions). Another example action is redesigning the cloud deployment of the application.

One technical advantage of the systems and methods of the present disclosure is creating a new data structure organizing the data from the traces allowing the attribution of cost of the microservices to each of the application traces. Granular data, such as, how much each feature costs based on the cost of the microservices involved in a feature, can inform business and finance teams on generating optimal strategies on the cost per subscription, actions to take in modifying an application, or actions to take in modifying a deployment of an application. Another technical advantage of the systems and methods of the present disclosure is resource management. In some implementations, the recommendations provided by the systems and methods suggest which cloud resources to decommission to reduce costs, and which network resources to leverage to enhance profitability and optimize network resource utilization, providing greater efficiency and financial performance for the application. Example cloud resources include compute resources, such as virtual machine central processing units (CPUs) and random access memory (RAM).

The systems and methods of the present disclosure help users draw insights into the cloud cost helping users make decisions or perform actions based on the cost incurred by features within the applications. One example use of the systems and methods of the present disclosure is redesigning an application based on cost to optimize the application using the cloud service infrastructure. Another example use of the systems and methods of the present disclosure is redesigning a cloud deployment of the application to reduce a cost of the application on a cloud service provider. Another example use of the systems and methods of the present disclosure is decommissioning resources in response to a recommendation provided based on the cost of the application. Another example use of the systems and methods of the present disclosure is leveraging resources in response to a recommendation provided based on the cost of the application. Another example use of the systems and methods of the present disclosure is changing a pricing structure of features of the application to increase profitability of the application.

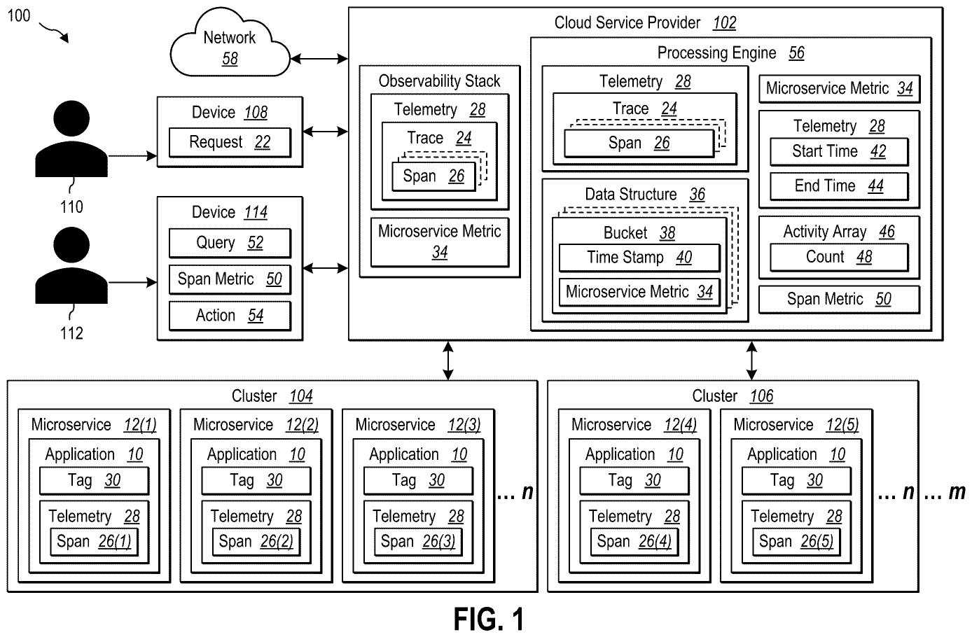

Referring now to FIG. 1, illustrated is an example environment 100 for identifying metrics of features of an application 10 running on a cloud service provider 102. While one application 10 is illustrated, the environment 100 may be used for a plurality of applications running on the cloud service provider 102. The environment 100 includes a cloud service provider 102 with a plurality of clusters 104, 106 up to m (where m is a positive integer). While two clusters 104, 106 are illustrated, any number of clusters may be part of the cloud service provider 102. In some implementations, the clusters 104, 106 are grouped by geographic location (e.g., a region of clusters). In some implementations, the clusters 104, 106 are implemented across multiple geographic locations (e.g., at different datacenters in different geographic regions). In some implementations, the clusters 104, 106 are in different geographic regions. In some implementations, the clusters 104, 106 are in a same geographic region.

Each of the clusters 104, 106 may include a variety of servers. Each of the clusters 104, 106 may include any number of virtual machines. Each of the clusters 104, 106 include a plurality of microservices up to n (where n is a positive integer) that are used by the cloud service provider 102 to run tasks of the application 10. Microservices structures the application 10 as a collection of services and communicate through application programming interfaces (APIs). Each microservice is an independent component that performs tasks for the application 10. For example, a microservice performs a task for a subdomain of the application, such as ‘user authentication’ or ‘email notifications.’ In some implementations, a microservice performs a specific task. For example, the microservice performs a task for a subfunction of the application. In some implementations, a microservice performs multiple tasks. For example, the microservice performs a plurality of tasks for a subfunction of the application. In some implementations, a microservice is used by multiple applications. For example, a currency conversion microservice is accessed by a plurality of applications for use with the applications. Microservices are independently deployable and communicate through application programming interfaces (APIs). In some implementations, the microservices use synchronous communication using the APIs. In some implementations, the microservice use asynchronous messaging (e.g., event-driven communication). While the cluster 104 is illustrated with three microservices (the microservice 12(1), the microservice 12(2), the microservice 12(3)) and the cluster 106 is illustrated with two microservices (the microservice 12(4) and the microservice 12(5)), each of the clusters 104, 106 may include any number of microservices.

In some implementations, the cloud service provider 102 hosts a plurality of applications 10 that a user 110 accesses via a device 108 through a network 58. For example, the application 10 is hosted on virtual machines in the clusters 104, 106. For example, a uniform resource locator (URL) configured to an end point of the application 10 is provided to the device 108 that the user 110 may access using a browser on the device 108 through the network 58. The network 58 may include one or multiple networks and may use one or more communication platforms and/or technologies suitable for transmitting data. The network 58 may refer to any data link that enables transport of electronic data between devices of the environment 100. The network 58 may refer to a hardwired network, a wireless network, or a combination of a hardwired network and a wireless network. In one or more implementations, the network 58 includes the internet. In some implementations, multiple users access the applications 10 using a plurality of devices.

In some implementations, the user 110 provides a request 22 to access the application 10. In some implementations, the application 10 is running across a plurality of microservices. For example, the application 10 runs on the microservice 12(1), the microservice 12(2), and the microservice 12(3) of the cluster 104. Another example includes the application 10 runs on the microservice 12(1) and the microservice 12(2) of the cluster 104 and the microservice 12(4) and the microservice 12(5) of the cluster 106. The request 22 triggers a trace 24 of the request 22. A trace 24 represents data or an execution path through the system. A trace 24 is a full request lifecycle as a request 22 moves through a distributed system. For example, when a user 110 makes a hypertext transfer protocol (HTTP) request, the trace 24 starts at the request 22, going through all the necessary microservices (e.g., the microservices 12(4), 12(5)), APIs, data accesses, etc. until the request 22 comes back with a HTTP status code (and maybe a response). For example, the trace 24 represents the different microservices of the application 10 accessed for the request 22. For example, the trace 24 is a direct acyclic graph of spans 26. A span 26 represents a logic unit of work that has an operation name, a start time of the operation, a duration of the operation. Spans 26 may be nested and ordered to model causal relationships. In some implementations, the trace 24 includes a plurality of spans 26.

In some implementations, each span 26 occurs on a single microservice in the cluster. For example, a span 26(1) occurs on the microservice 12(1) in the cluster 104, a span 26(2) occurs on the microservice 12(2) in the cluster 104, a span 26(3) occurs on the microservice 12(3) in the cluster 104, a span 26(4) occurs on the microservice 12(4) in the cluster 106, and a span 26(5) occurs on the microservice 12(5) in the cluster 106. In some implementations, the spans 26 of the trace 24 occur on multiple microservices in the cluster. For example, a first span 26(1) occurs on the microservice 12(1) and a second span 26(3) occurs on the microservice 12(3) in the cluster 104. In some implementations, the spans 26 for the trace 24 occur on multiple microservices across different clusters. For example, a first span 26(1) occurs on the microservice 12(2) of the cluster 104, a second span 26(4) occurs on the microservice 12(4) of the cluster 106, and the third span 26(5) occurs on the microservice 12(5) of the cluster 106. The telemetry 28 obtains the data associated with the trace 24 and the spans 26 generated in response to the request 22.

In some implementations, a tag 30 is added to the application 10 to obtain telemetry 28 of the application 10 related to the tag 30. In some implementations, the tag 30 is selected for an area of interest. For example, the tag 30 is a user session. Another example of the tag 30 is a workflow in the application 10. Another example of the tag 30 is a feature of the application 10. In some implementations, as the application 10 operates, the telemetry 28 associated with the tag 30 is automatically captured. For example, the data exchange for an identified workflow in the application 10 is captured in the telemetry 28. In some implementations, a plurality of tags 30 are added to the application 10 to obtain telemetry 28 of different areas of interest of the application 10. In some implementations, the tag 30 is selected based on an interest of a business team operating the application 10. In some implementations, the tag 30 is selected by an application developer to monitor a performance of a workflow in the application 10. The tags 30 provide flexibility of the telemetry 28 obtained for the application 10 allowing the information obtained from the application 10 to be tailored to different interests or preferences.

An observability stack 32 receives the telemetry 28 for the trace 24. The telemetry 28 identifies the spans 26 for the trace 24 generated by the application 10. In some implementations, the observability stack 32 receives the telemetry 28 for the trace 24 associated with the tag 30 (e.g., the telemetry 28 of the area of interest identified by the tag 30). In some implementations, the observability stack 32 receives a microservice metric 34 that identifies a metric of running the microservices (e.g., cost of the microservice 12(1) in the cluster 104, cost of the microservice 12(2) in the cluster 104, cost of the microservice 12(3) in the cluster 104, cost of the microservice 12(4) in the cluster 106, and cost of the microservice 12(5) in the cluster 106). In some implementations, the microservice metric 34 is a monetary value for running the microservice. In some implementations, the microservice metric 34 is an amount of resources in the cluster used by the microservice.

A processing engine 56 in communication with the observability stack 32 receives the telemetry 28 for the trace 24 with the spans 26 and the microservice metric 34. The processing engine 56 generates a data structure 36 that associates the microservice metric 34 for each microservice to a time stamp 40. The data structure 36 includes a plurality of buckets 38 for a microservice. A bucket 38 is a unit of time for the data. In some implementations, a bucket 38 includes a time stamp 40. For example, the time stamp 40 corresponds to one second of a day and each bucket 38 corresponds to a second of operation for the microservice. In some implementations, a bucket 38 includes a microservice metric 34 for the time stamp 40, and a bucket 38 represents the cost of one microservice for one second. Different microservices have different buckets and associated costs for operating the individual microservices.

In some implementations, the processing engine 56 implements an algorithm to cross reference the telemetry 28 and the microservice metric 34 to identify a metric for a unit of work (e.g., a span 26) in the application 10. For example, the processing engine 56 uses the algorithm to determine how much an atomic (lowest) unit of work costs per second per user of an application 10. In some implementations, the processing engine 56 sums the individual units of metrics (e.g., a metric per span 26) over a range of time specified in the trace 24 to get a total cost of a workflow. In some implementations, the processing engine 56 sums the individual units of metrics (e.g., a metric per span 26) to determine the cost per user using the application 10.

In some implementations, the processing engine 56 identifies for each span 26 a start time 42 of the span 26 and an end time 44 of the span 26. The processing engine 56 splits the span 26 into seconds using the start time 42 and the end time 44 of the span 26. The processing engine 56 associates the seconds of the span 26 to the buckets 38 of the data structure 36 and determines the number of buckets 38 of the microservice where the span 26 occurs. For example, a span 26 covering four seconds is associated with four buckets 38 of the data structure 36 occurring at the same time of the span 26.

In some implementations, the processing engine 56 determines a span metric 50 by adding the microservice metric 34 for each second that the span 26 occurs. The processing engine 56 identifies the buckets 38 of the data structure 36 associated with the span 26 and sums the microservice metrics 34 for each bucket 38 identified. For example, the processing engine 56 identifies the buckets 38 of the data structure 36 that occur between the start time 42 and the end time 44 of the span 26 and sums the microservice metric 34 from each bucket 38 of the data structure 36 between the start time 42 and the end time 44.

In some implementations, the processing engine 56 updates a count 48 in an activity array 46 for the microservice during each bucket 38 that the span 26 occurs. The count 48 shows the number of active spans 26 during each second of microservice operation. The count 48 identifies the number of concurrent requests for each second of the microservice operation. In some implementations, the count 48 identifies the number of users for each second of the microservice operation. In some implementations, the count 48 identifies the number of concurrent spans during each second of the microservice operation. In some implementations, the activity array 46 includes a plurality of microservices, where each microservice has a count 48 for each bucket 38 of the microservice.

In some implementations, the processing engine 56 uses the count 48 in the activity array 46 to determine a metric for each request of a microservice. The processing engine 56 fractions the microservice metric 34 based on the count 48 (the number of concurrent requests) for each bucket 38 of the microservice. For example, the processing engine 56 divides the span metric 50 by the count 48 to determine the cost per request for each second of the microservice operation. One example metric is a monetary cost for each user of a microservice for each second the microservice operation. For example, the processing engine 56 divides the span metric 50 by the count 48 to determine the monetary cost per user for each second of the microservice operation. Another example metric is resource cost for each user of a microservice. In some implementations, the processing engine 56 divides the span metric 50 by the count 48 for each bucket 38 to determine the resource cost per request for each bucket 38 and adds the resource cost per request over the entire span 26 (e.g., the buckets 38 included in the span 26) to determine the resource cost per request for the span 26.

The span metric 50 is used to attribute the cost of the microservice to each of the application traces 24. In some implementations, the span metric 50 is used to formulate queries to report the cost of sub-application-level features based on one or more tags 30 of interest. For example, an end user 112 creates a query 52 for an area of interest in the application 10 (e.g., a workflow in the application, specific feature of the application, user group, etc.) and the span metric 50 associated with the tags 30 of the area of interest is obtained in response to the query 52 and presented to the end user 112 on the device 114. One example of the end user 112 is an application designer. Another example of the end user 112 is an engineering team member. Another example of the end user 112 is a business team member. In some implementations, the end user 112 is also the user 110.

In some implementations, the span metric 50 is presented on a dashboard on the device 114 and the end user 112 uses the span metric 50 to make decisions or perform actions 54 on the application 10. In some implementations, the span metric 50 is generated in a report provided to the end user 112 and presented on the device 114. In some implementations, the span metric 50 is sent to the end user 112 (e.g., in an email message or other message).

One example action 54 the end user 112 makes is redesigning the application 10 based on cost to optimize the application 10 using the cloud service infrastructure. For example, an application designer may remove a workflow or feature from the application 10 in response to the span metric 50 information. Another example action 54 includes an application designer modifying a feature in the application 10 in response to the span metric 50 information. For example, a feature in an application 10 brings in $100 in profit while the infrastructure costs $500 to maintain the feature in the application 10. The business team may shut down the feature of the application 10, optimize the feature, or downgrade the infrastructure of the application 10 in response to the span metric 50 information provided for the feature. Another example action 54 includes a business team member changing a pricing structure of features of the application 10 to increase profitability of the application 10 in response to the span metric 50 information.

Another example action 54 is redesigning a cloud deployment of the application 10 to reduce a cost of the application 10 on a cloud service provider 102. For example, an engineering team member decommissions network resources in response to the span metric 50 information. Another example includes the engineering team member leveraging resources in response to the span metric 50 of the application 10. Another example includes an engineering team member using the span metrics 50 in determining resource allocation for the application 10 and designing software architecture for the application 10 (e.g., offloading some work to different pods, or organizing microservices such that there is a one-to-one mapping between APIs and services for easy tracing).

In some implementations, the span metric 50 information is presented on the device 108 as the user 110 is accessing the application 10. For example, a user interface on the device 108 displays the span metric 50 information for the request 22 the user 110 is making for the application 10. The span metric 50 information is provided to the device 108 by the processing engine 56 in response to receiving the request 22. The user 110 may use the span metric 50 information in making decisions for using the application 10. For example, the user 110 may stop using a feature of the application 10 in response to the span metric 50 information. Another example includes the user 110 using a different feature of the application 10 in response to the span metric 50 information. Another example includes the user 110 using a different application in response to the span metric 50 information.

One example includes the user 110 is using the application 10 to have a chat session with an artificial intelligence (AI) agent that is executing oilfield simulations in the background, the running cost of the user session with the AI agent cost and the simulation engine cost may be getting expensive. The span metric 50 information may include the costs added together (e.g., the AI agent cost, the simulation engine cost, and the cost of the microservice for the application 10). The span metric 50 may be presented to the user 110 while the user 110 is conducting the chat session notifying the user 110 of the cost associated with the chat session.

The environment 100 uses telemetry 28 of applications 10 that is cross-referenced with the infrastructure metrics and billing data to attribute costs of different features of the application 10. By providing costs of the different features of the application 10, the cloud costs are provided to the end users 112 helping the end users 112 make decisions based on the cost incurred by the applications 10. For example, engineering and business teams may make more data-driven decisions around pricing, deployment, and design of the application 10.

In some implementations, one or more computing devices (e.g., servers and/or devices) are used to perform the processing of the environments 100. The one or more computing devices may include, but are not limited to, server devices, cloud virtual machines, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. Moreover, in some implementations, one or more subcomponents of the features and functionalities discussed herein are processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

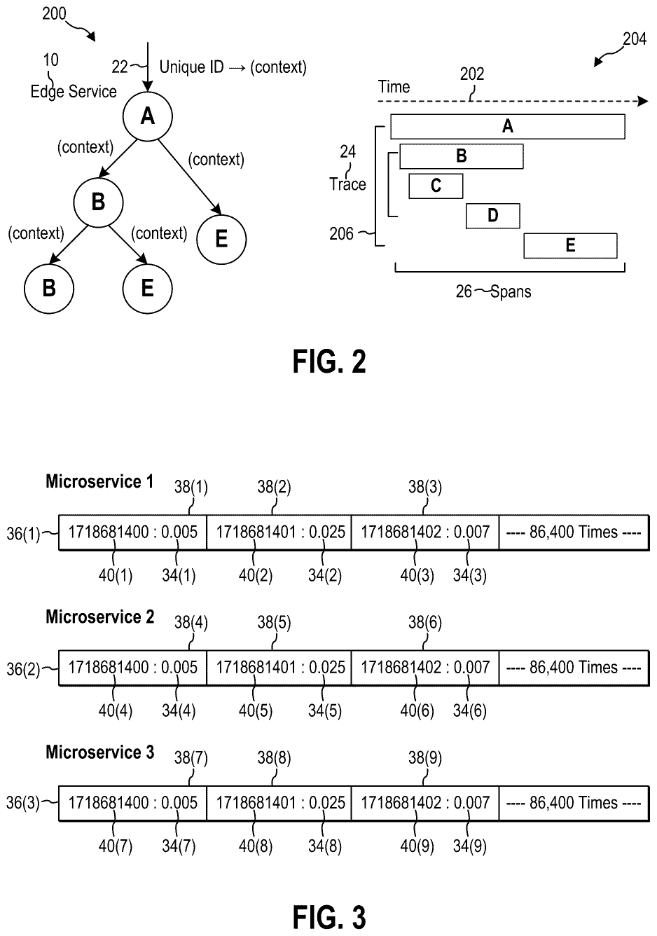

FIG. 2 illustrates an example of a trace 24 and a span 26 of an application 10. For example, the application 10 is provided by the cloud service provider 102 (FIG. 1) on the clusters 104 (FIG. 1) and 106 (FIG. 1) with a first microservice (e.g., the microservice 12(1) (FIG. 1)) supporting span A (e.g., the span 26(1) (FIG. 1)), a second microservice (e.g., the microservice 12(2) (FIG. 1)) supporting span B (e.g., the span 26(2) (FIG. 1)), a third microservice (e.g., the microservice 12(3) (FIG. 1)) supporting span C (e.g., the span 26(3) (FIG. 1)), a fourth microservice (e.g., the microservice 12(4) (FIG. 1)) supporting span D (e.g., the span 26(4) (FIG. 1)), and a fifth microservice (e.g., the microservice 12(5) (FIG. 1)) supporting span E (e.g., the span 26(5) (FIG. 1)).

A graph 200 illustrates different traces 24 in the application 10. The different traces 24 represent an execution path through the application 10. An example first trace includes span A and span E. An example second trace includes span A, span B, and span D. An example third trace includes span A, span B, and span C. An example fourth trace includes span A, span B, span C, and span D. An example fifth trace includes span A, span E, and span B. An example sixth trace includes span A, span E, span B, and span C. An example seventh trace includes span A, span E, span B, and span D. An example eight trace includes span A, span E, span B, span C, and span D. In some implementations, the different traces 24 are determined in response to a request 22 received by a user 110 (FIG. 1).

A graph 204 illustrates the spans 26 (e.g., the span A, the span B, the span C, the span D, the span E) along an x-axis 202 across a period of time. Each span 26 includes a start time 42 (FIG. 1) and an end time 44 (FIG. 1). The y axis 206 illustrates different traces 24. In some implementations, the spans 26 are nested and ordered to model causal relationships.

In some implementations, the processing engine 56 uses the units of time for each span 26 in an algorithm to determine the span metric 50 (FIG. 1) for each span 26. For example, the processing engine 56 determines the span metric 50 for span A, the span metric 50 for span B, the span metric 50 for span C, the span metric 50 for span D, and the span metric 50 for span E. In some implementations, an end user 112 (FIG. 1) provides a query for a trace 24 and receives the span metric 50 for each span in the trace 24. For example, the query is for a trace 24 that includes span A and span E, and the processing engine 56 provides the span metric 50 for span A and the span metric 50 for span E in response to the query. In some implementations, the processing engine 56 aggregates the cost of the spans 26 to determine a cost of a trace 24. For example, the processing engine 56 determines a cost of a trace 24 for a workflow using span A and span E by aggregating the span metric 50 for span A and span E and providing the total cost of the trace 24 to the end user 112 in response to the query. In some implementations, the cost is a monetary value. In some implementations, the cost is an amount of resources used.

FIG. 3 illustrates an example data structure 36 for different microservices (e.g., the microservices 12(1), 12(2), and 12(3) (FIG. 1)) created by the processing engine 56 (FIG. 1) with unit timestamps and a cost value. For example, a first data structure 36(1) is for a first microservice (e.g., the microservice 12(1)), a second data structure 36(2) is for a second microservice (e.g., the microservice 12(2)), and a third data structure 36(3) is for a third microservice (e.g., the microservice 16).

In some implementations, the data structure 36 includes different buckets 38 for each microservice where one bucket 38 represents the microservice metric 34 for one second. For one day there is 86,400 seconds and the data structure 36 includes 86,400 buckets for a microservice. In the illustrated example, the buckets 38 for the first microservice, the second microservice, and the fourth microservice are at the same time of day (e.g., are showing the buckets 38 with the time stamps 40 for the same seconds.

The first data structure 36(1) includes a first bucket 38(1) with a time stamp 40(1) of 1718681400 and a microservice metric 34₁ of $ 0.005, a second bucket 38(2) with a time stamp 40(2) of 1718681401 and a microservice metric 34₂ of $ 0.025, and a third bucket 38(3) with a time stamp 40(3) of 1718681402 and a microservice metric 34₃ of $ 0.007.

The second data structure 36(2) includes a first bucket 38(4) with a time stamp 40(4) of 1718681400 and a microservice metric 34₄ of $ 0.045, a second bucket 38(5) with a time stamp 40(5) of 1718681401 and a microservice metric 34₅ of $ 0.50, and a third bucket 38(6) with a time stamp 40(6) of 1718681402 and a microservice metric 34₆ of $ 0.001. The third data structure 36(3) includes a first bucket 38(7) with a time stamp 40(7) of 1718681400 and a microservice metric 34₇ of $ 0.23, a second bucket 38(8) with a time stamp 40(8) of 1718681401 and a microservice metric 34₈ of $ 0.0, and a third bucket 38(9) with a time stamp 40(9) of 1718681402 and a microservice metric 34₉ of $ 0.05. In some implementations, the processing engine 56 uses the data structures 36(1), 36(2), 36(3) to attribute the cost of the microservice to each application trace 24 (FIG. 1).

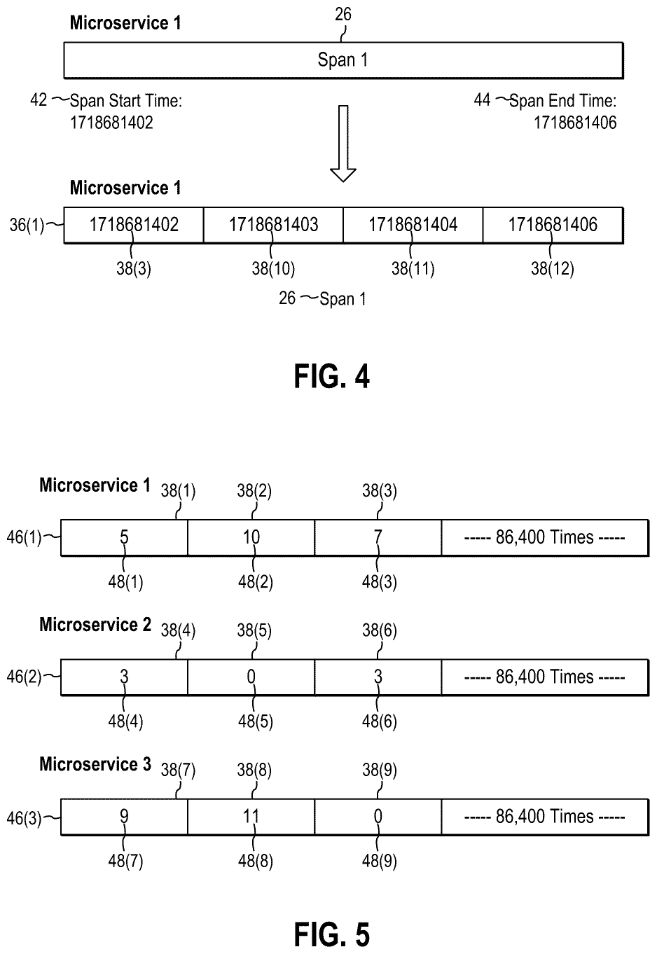

FIG. 4 illustrates an example span 26 divided into buckets 38 of a data structure 36 (FIG. 1)). In some implementations, the processing engine 56 (FIG. 1) identifies the span start time 42 and the span end time 44 from the telemetry 28 (FIG. 1) provided for the span 26. For example, the time stamp of the span start time 42 is 1718681402 and the time stamp of the span end time 44 is 1718681406. The processing engine 56 uses the span start time 42 and the span end time 44 to determine that the span 26 takes four seconds to complete.

In some implementations, the processing engine 56 determines that the span 26 occurs on the first microservice (e.g., the microservice 1 (FIG. 3)) from the telemetry 28 and obtains the data structure 36(1) associated with the first microservice. The processing engine 56 uses the time stamps of the span 26 to map the span 26 to the buckets 38 of the data structure 36(1) of the first microservice. For example, the first second of the span 26 starts at the bucket 38(3), the second of the span 26 is at the bucket 38(10) the third second of the span 26 is at the bucket 38(11), and the fourth second of the span 26 is at the 38(3). The processing engine 56 sums the span metric 50 (FIG. 1) for the bucket 38(3), the span metric 50 for the bucket 38(10), the span metric 50 for the bucket 38(11), and the span metric 50 for the bucket 38(12) to get the total cost for the span 26 on the first microservice. In some implementations, the total cost is a monetary value. In some implementations, the total cost is an amount of resources used.

In some implementations, a workflow in the application 10 (FIG. 1) includes a plurality of spans 26 spanning a plurality of microservices. The processing engine 56 repeats the process described in FIG. 4 for each span 26 in the workflow for each microservice and sums the total cost for each span 26 in the workflow to obtain the cost per workflow in the application 10.

FIG. 5 illustrates an example activity array 46 for different microservices (e.g., the microservices 12(1), 12(2), and 16 (FIG. 1)) created by the processing engine 56 (FIG. 1) with the number of active spans 26 (FIG. 1) at a second of operation for the microservices. For example, a first activity array 46(1) is for a first microservice (e.g., the microservice 12(1)), a second activity array 46(2) is for a second microservice (e.g., the microservice 12(2)), and a third activity array 46(3) is for a third microservice (e.g., the microservice 16).

In some implementations, the activity array 46 includes different buckets 38 with a count 48 of the number of active spans 26 for one second of operation for a microservice. For one day there is 86,400 seconds and the activity array 46 includes 86,400 buckets for a microservice. For example, the first activity array 46(1) includes a first bucket 38(1) with a count 48(1) of 5 active spans 26, a second bucket 38(2) with a count 48(2) of 10 active spans 26, and a third bucket 38(3) with a count 48(3) of 7 active spans 26.

The second activity array 46(2) includes a first bucket 38(4) with a count 48(4) of 3 active spans 26, a second bucket 38(5) with a count 48(5) of 0 active spans 26, and a third bucket 38(6) with a count 48(6) of 3 active spans 26. The third activity array 46(3) includes a first bucket 38(7) with a count 48(7) of 9 active spans 26, a second bucket 38(8) with a count 48(8) of 11 active spans 26, and a third bucket 38(9) with a count 48(9) of 0 active spans 26.

In some implementations, the processing engine 56 uses the activity arrays 46(1), 46(2), 46(3) to attribute the span metric 50 (FIG. 1) to each user. The count 48 indicates the number of active spans 26 on a microservice and the processing engine 56 uses the count 48 to determine a number of users using the microservice. For example, each user corresponds to one active span 26 on the microservice. In some implementations, the processing engine 56 divides the total cost of the span 26 by the count 48 to determine the cost per user. For example, if a microservice has a count 48 equal to five, the processing engine 56 determines that five users are using the microservice and divides the total cost of the span by five to determine the cost per user.

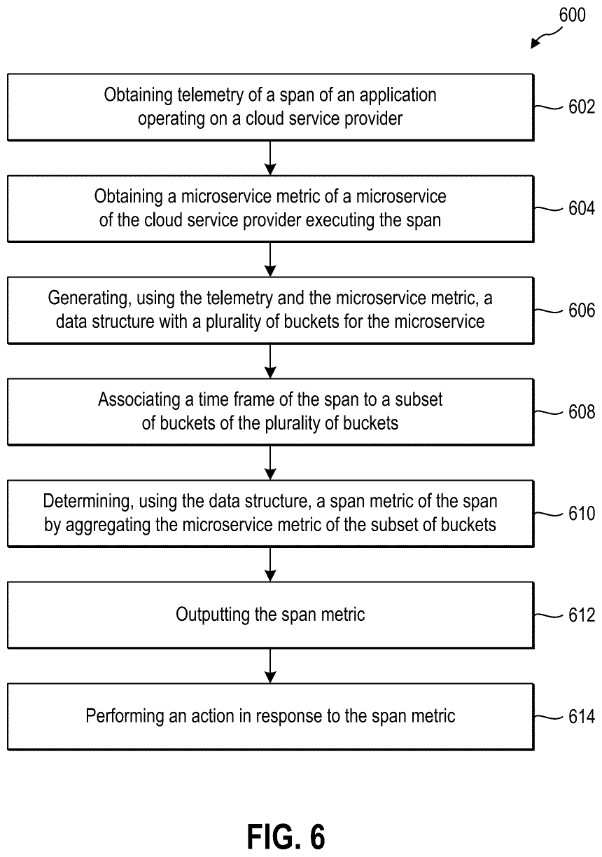

FIG. 6 illustrates an example method 600 for identifying metrics of features of an application 10 (FIG. 1) running on a cloud service provider 102 (FIG. 1). The actions of the method 600 are discussed below in reference to FIGS. 1-5.

At 602, the method 600 includes obtaining telemetry of a span of an application operating on a cloud service provider. In some implementations, the processing engine 56 obtains the telemetry 28 of a span 26 of an application 10 operating on a cloud service provider 102. In some implementations, the processing engine 56 obtains telemetry of a trace 24 including a plurality of spans 26 of the application 10 operating on the cloud service provider 102. In some implementations, the telemetry 28 of the application 10 is automatically obtained by the processing engine 56 in response to a request 22 to access the application 10.

At 604, the method 600 includes obtaining a microservice metric of a microservice of the application running on the cloud service provider executing the span. In some implementations, the processing engine 56 obtains the microservice metric 34 of the microservice (e.g., the microservice 12(1)) of the application 10 running on the cloud service provider 102 executing the span (e.g., the span 26(1)). In some implementations, the microservice metric 34 is a dollar value. In some implementations, the microservice metric 34 is an amount of resources of the cloud service provider 102 used to support the microservice.

In some implementations, a plurality of microservices (e.g., the microservice 12(1), the microservice 12(2), the microservice 16) of the cloud service provider 102 execute the plurality of spans (e.g., the span 26(1), the span 26(2), the span 26(3)) and each span of the plurality of spans is executed by a different microservice of the plurality of microservices. In some implementations, the processing engine 56 obtains the microservice metric 34 for each microservice of the plurality of microservices executing the plurality of spans.

At 606, the method 600 includes generating, using the telemetry and the microservice metric, a data structure with a plurality of buckets for the microservice. In some implementations, the processing engine 56 generates a data structure 36 with a plurality of buckets 38 for the microservice (e.g., the microservice 12(1)). In some implementations, each bucket 38 of the plurality of buckets includes a time stamp 40 and the microservice metric 34 for the time stamp 40. In some implementations, the time stamp 40 corresponds to one second of the day.

At 608, the method 600 includes associating a time frame of the span to a subset of buckets of the plurality of buckets. In some implementations, the processing engine 56 associates a time frame of the span 26 to a subset of buckets of the plurality of buckets 38. In some implementations, the processing engine 56 identifies a start time 42 and an end time 44 of the span 26 in determining the time frame of the span 26. In some implementations, the processing engine 56 compares the time frame of the span 26 to the time stamp 40 of a bucket 38 and associates the span 26 to the bucket 38 in response to a match occurring between the time frame and the time stamp 40. In some implementations, the processing engine 56 compares each second of the time frame of the span 26 to a time stamp 40 of a bucket 38 and adds the bucket 38 to the subset of buckets in response to a match occurring between the second and the time stamp 40.

At 610, the method 600 includes determining, using the data structure, a span metric of the span by aggregating the microservice metric of the subset of buckets. In some implementations, the processing engine 56 determines the span metric 50 of the span 26 by aggregating the microservice metric 34 of the subsets of buckets using the data structure 36. In some implementations, the processing engine 56 determines the span metric 50 of a plurality of spans 26 by aggregating the microservice metrics of the subset of buckets for the plurality of spans 26 using the data structure 36 for each microservice.

In some implementations, the processing engine 56 determines a cost per request of the span 26 by generating an activity array 46 with a count 48 of active spans 26 for each bucket 38 of the plurality of buckets and dividing the span metric 50 by the count 48. In some implementations, the count 48 identifies a number of concurrent requests using the microservice during the time stamp 40. In some implementations, the processing engine 56 outputs the cost per request of the span 26. In some implementations, the processing engine 56 uses a session identification (ID) and user ID along with the activity array 46 in determining a cost per user.

At 612, the method 600 includes outputting the span metric. In some implementations, the processing engine 56 outputs the span metric 50. For example, the span metric 50 is output on a display of the device 114 of the end user 112. In some implementations, the span metric 50 is output in response to a query 52 received by the processing engine 56. For example, the end user 112 provides a query 52 for the span metric 50 to the processing engine 56 and the processing engine 56 outputs the span metric 50 in response to the query 52.

In some implementations, the query 52 is for the span metric 50 of an area of interest. In some implementations, the application 10 includes a tag 30 identifying the area of interest in the application 10. The processing engine 56 obtains the telemetry 28 of the application 10 for the area of interest using the tag 30 associated with the area of interest. One example area of interest includes a feature of the application 10, and the telemetry 28 is obtained for the feature using the tag 30. Another example area of interest includes a user group of the application, and the telemetry 28 is obtained for the user group using the tag 30. Another example area of interest includes a workflow in the application 10, and the telemetry 28 is obtained for the workflow using the tag 30.

In some implementations, the processing engine 56 obtains the telemetry 28 of the application 10 for the area of interest using the tag 30 and identifies the span 26 for the area of interest using the tag 30. The processing engine 56 identifies the span metric 50 for the span 26 for the area of interest using the data structure 36. The processing engine 56 provides a response to the query 52 with the span metric 50 for the area of interest.

In some implementations, the processing engine 56 identifies an external cost to external services associated with the application 10 and includes the external cost in the span metric 50. For example, a span 26 makes an external call to an external generative artificial intelligence (AI) service and the processing engine 56 tracks the external cost of calling the generative AI service. One example of the external cost includes token counts and cost per token of using the generative AI service. The processing engine 56 adds the external cost to the span metric 50 and outputs the total cost (e.g., the span metric 50 and the external cost) for the span 26.

At 614, the method 600 includes performing an action in response to the span metric. In some implementations, an action 54 is performed in response to the span metric 50. In some implementations, an end user 112 performs the action 54 in response to the span metric 50. In some implementations, the cloud service provider 102 performs the action 54 in response to the span metric 50.

In some implementations, the action 54 includes modifying a design of the application 10 in response to the span metric 50. In some implementations, the action 54 includes modifying resources of the cloud service provider 102 supporting the application 10 in response to the span metric 50. In some implementations, the action 54 includes removing a feature of the application 10 in response to the span metric 50. In some implementations, the action 54 includes redesigning the application 10 in response to the span metric 50. In some implementations, the action 54 includes removing a workflow from the application 10 in response to the span metric 50. In some implementations, the action 54 includes redesigning a cloud deployment of the application 10 on the cloud service provider 102 in response to the span metric 50. In some implementations, the action 54 includes leveraging resources of the cloud service provider 102 in response to the span metric 50. In some implementations, the action 54 includes decommissioning resources of the cloud service provider 102 in response to the span metric 50. In some implementations, the action 54 includes changing a pricing structure of a feature of the application 10 to increase profitability of the application 10 in response to span metric 50.

The method 600 attributes costs of different features of the application 10 using the telemetry 28. Providing costs of the different features of the application 10, helps the end users 112 make more data-driven decisions and actions around pricing, deployment, and design of the application 10.

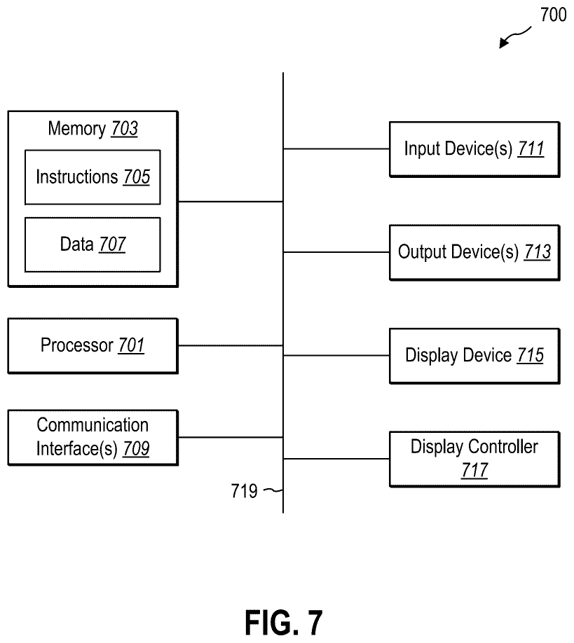

FIG. 7 illustrates components that may be included within a computer system 700. One or more computer systems 700 may be used to implement the various methods, devices, components, and/or systems described herein.

The computer system 700 includes a processor 701. The processor 701 may be a general-purpose single or multi-chip microprocessor (e.g., an Advanced RISC (Reduced Instruction Set Computer) Machine (ARM)), a special purpose microprocessor (e.g., a digital signal processor (DSP)), a graphics processing unit (GPU), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and light pen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For the sake of clarity, the various buses are illustrated in FIG. 7 as a bus system 719.

In some implementations, the various components of the computer system 700 are implemented as one device. For example, the various components of the computer system 700 are implemented in a mobile phone or tablet. Another example includes the various components of the computer system 700 implemented in a personal computer. Another example includes the various components of the computer system 700 implemented in the cloud. Another example includes the various components of the computer system 700 implemented on an edge device.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. There is no intention to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method comprising:
obtaining telemetry of a span of an application operating on a cloud service provider;
obtaining a microservice metric of a microservice of the application running on the cloud service provider executing the span;
generating, using the telemetry and the microservice metric, a data structure with a plurality of buckets for the microservice, wherein each bucket of the plurality of buckets includes a time stamp and the microservice metric for the time stamp;
associating a time frame of the span to a subset of buckets of the plurality of buckets;
determining, using the data structure, a span metric of the span by aggregating the microservice metric of the subset of buckets;
outputting the span metric; and
performing an action in response to the span metric.

2. The method of claim 1, wherein the action includes modifying a design of the application in response to the span metric.

3. The method of claim 1, wherein the action includes modifying resources of the cloud service provider supporting the application in response to the span metric.

4. The method of claim 1, wherein the action includes removing a feature of the application in response to the span metric.

5. The method of claim 1, wherein the application includes a tag identifying an area of interest of the application.

6. The method of claim 5, further comprising:
obtaining, using the tag, the telemetry of the application for the area of interest.

7. The method of claim 6, wherein the area of interest is a feature of the application, and the telemetry is obtained for the feature.

8. The method of claim 6, wherein the area of interest is a user group of the application, and the telemetry is obtained for the user group.

9. The method of claim 5, further comprising:
receiving a query for the span metric of the area of interest;
identifying, using the tag, the span for the area of interest;
determine, using the data structure, the span metric of the span for the area of interest; and
providing a response to the query with the span metric for the area of interest.

10. The method of claim 1, further comprising:
generating an activity array with a count of active spans for each bucket of the plurality of buckets, wherein the count identifies a number of concurrent requests using the microservice during the time stamp.

11. The method of claim 10, further comprising:
calculating, using the activity array, a metric per request of the span by dividing the span metric by the count; and
outputting the metric per request of the span.

12. The method of claim 10, further comprising:
obtaining the telemetry for a trace of the application, wherein the trace includes a plurality of spans and a plurality of microservices of the cloud service provider execute the plurality of spans, wherein each span of the plurality of spans is executed by a different microservice of the plurality of microservices.

13. The method of claim 12, further comprising:
obtaining the microservice metric for each microservice of the plurality of microservices;
generating, using the telemetry and the microservice metric, the data structure with the plurality of buckets for each microservice of the plurality of the microservices, wherein each bucket of the plurality of buckets includes the time stamp and the microservice metric for the time stamp;
determining, using the data structure for each microservice, the span metric of the plurality of spans by aggregating the microservice metric of the subset of buckets for the plurality of spans; and
outputting the span metric of the plurality of spans.

14. A device, comprising:
a memory to store data and instructions; and
a processor operable to communicate with the memory, wherein the processor is operable to:
obtain telemetry of a span of an application operating on a cloud service provider;
obtain a microservice metric of a microservice of the application running on the cloud service provider executing the span;
generate, using the telemetry and the microservice metric, a data structure with a plurality of buckets for the microservice, wherein each bucket of the plurality of buckets includes a time stamp and the microservice metric for the time stamp;
associate a time frame of the span to a subset of buckets of the plurality of buckets;
determine, using the data structure, a span metric of the span by aggregating the microservice metric of the subset of buckets; and
perform an action in response to the span metric.

15. The device of claim 14, wherein the time frame of the span is determined by identifying a start time of the span and an end time of the span.

16. The device of claim 14, wherein the time stamp corresponds to one second of a day.

17. The device of claim 14, wherein the action includes redesigning the application, removing a workflow from the application, redesigning a cloud deployment of the application, leveraging resources of the cloud service provider, or decommissioning resources of the cloud service provider.

18. The device of claim 14, wherein the processor is further operable to:
receive a query for the span metric for an area of interest;
obtain, using a tag associated with the area of interest, telemetry of the application for the area of interest;
identify, using the tag, the span for the area of interest;
determine, using the data structure, the span metric of the span for the area of interest; and
provide a response to the query with the span metric for the area of interest.

19. The device of claim 18, wherein the area of interest includes a feature of the application, a workflow in the application, or a user group of the application.

20. The device of claim 14, wherein the processor is further operable to:
generate an activity array with a count of active spans for each bucket of the plurality of buckets, wherein the count identifies a number of concurrent requests using the microservice during the time stamp;
calculate, using the activity array, a metric per request of the span by dividing the span metric by the count; and
output the metric per request of the span.
